(19) United States
(12) Patent Application Publication
(10) Pub. No.: US 2014/0241429 A1
(43) Pub. Date: Aug. 28, 2014

(54) IMAGE PROCESSING DEVICE

(71) Applicant: KABUSHIKI KAISHA TOSHIBA, Tokyo (JP)

(72) Inventors: Hajime Matsui, Yokohama-Shi (JP); Shuou Nomura, Yokohama-Shi (JP)

(73) Assignee: KABUSHIKI KAISHA TOSHIBA, Tokyo (JP)

(21) Appl. No.: 13/973,722

(22) Filed: Aug. 22, 2013

(30) Foreign Application Priority Data
Feb. 28, 2013 (JP) 2013-038916

(51) Int. Cl. H04N 7/36

(52) U.S. Cl. CPC H04N 19/00587
USPC 375/240.16

(57) ABSTRACT

According to one embodiment, an image processing device includes a first motion estimator and a second motion estimator. The first motion estimator is configured to detect a second pixel of a second integer position in a reference frame, the second pixel corresponding to a first pixel of a first integer position in a base frame. The second motion estimator is configured to detect a decimal position from the first integer position in the base frame, the decimal position corresponding to the second pixel, and to output the decimal position and a value of the second pixel.

### CROSS REFERENCE TO RELATED APPLICATIONS

This application is based upon and claims the benefit of priority from the prior Japanese Patent Application No. 2013-38916, filed on Feb. 28, 2013, the entire contents of which are incorporated herein by reference.

### FIELD

Embodiments described herein relate generally to an image processing device.

### BACKGROUND

In order to improve the resolution of an image, there is a known a technique to estimate a pixel value at a decimal position in a base frame by referring to a plurality of frames. The technique is also referred to as super-resolution and includes two processes, which are motion estimation and image reconstruction. In the motion estimation, it is necessary to accurately estimate a positional relationship between a base frame and a reference frame.

If the motion estimation is performed on the base frame from the reference frame, there is a risk that deviation occurs in the decimal position in the corresponding base frame and the quality of a generated super-resolution image degrades.

Even when interpolation pixels are generated at the decimal position in both the base frame and the reference frame and both interpolation pixels are compared with each other, it is not necessarily possible to perform the motion estimation at a high degree of accuracy. This is because artifacts may occur when the interpolation pixels are generated.

### BRIEF DESCRIPTION OF THE DRAWINGS

FIG. 1 is a block diagram showing a schematic configuration of a resolution converter according to a first embodiment.

FIG. 2 is a block diagram of the motion estimator 300 according to the first embodiment.

FIG. 3 is a flowchart showing an example of the process of the motion estimator 300.

FIG. 4 is a diagram for explaining the process of the motion estimator 300.

FIG. 5 is a block diagram showing an example of a configuration of the decimal accuracy motion estimator 2.

FIGS. 6A to 6E are diagrams for explaining the process of the decimal accuracy motion estimator 2 in FIG. 5.

FIG. 7 is a block diagram showing another example of the decimal accuracy motion estimator 2.

FIG. 8 is a diagram for explaining the process of the decimal accuracy motion estimator 2 in FIG. 7.

FIG. 9 is a block diagram showing a schematic configuration of a motion estimator 300 according to the second embodiment.

FIG. 10 is a diagram for explaining the process of the motion estimator 300 in FIG. 9.

FIG. 11 is a diagram schematically showing information stored in the buffer 4.

FIG. 12 is a diagram for explaining the processing operation of the selector 3.

FIG. 13 is a diagram for explaining the processing operation of the selector 3.

FIG. 14 is a diagram for explaining the processing operation of the selector 3.

FIG. 15 is a block diagram showing a schematic configuration of a motion estimator 300 according to the third embodiment.

FIG. 16 is a diagram for explaining the process of the integer accuracy motion estimator 1.

FIG. 17 is a diagram schematically showing information stored in the buffer 4.

FIG. 18 is a diagram for explaining the processing operation of the selector 3.

FIG. 19 is a diagram for explaining the processing operation of the selector 3.

FIG. 20 is a diagram for explaining the processing

FIG. 21 is a block diagram showing a schematic configuration of the resolution converter according to the fourth embodiment.

FIG. 22 is a diagram showing an example of the processing result of the integer accuracy motion estimator in the motion estimator 300.

FIG. 23 is a diagram schematically showing information stored in the buffer 600.

FIG. 24 is a block diagram showing an overview of the resolution converter according to the fifth embodiment.

FIG. 25 is a diagram for explaining the process of the reverse search module 700.

### DETAILED DESCRIPTION

In general, according to one embodiment, an image processing device includes a first motion estimator and a second motion estimator. The first motion estimator is configured to detect a second pixel of a second integer position in a reference frame, the second pixel corresponding to a first pixel of a first integer position in a base frame. The second motion estimator is configured to detect a decimal position from the first integer position in the base frame, the decimal position corresponding to the second pixel, and to output the decimal position and a value of the second pixel.

Hereinafter, embodiments will be specifically described with reference to the drawings.

### First Embodiment

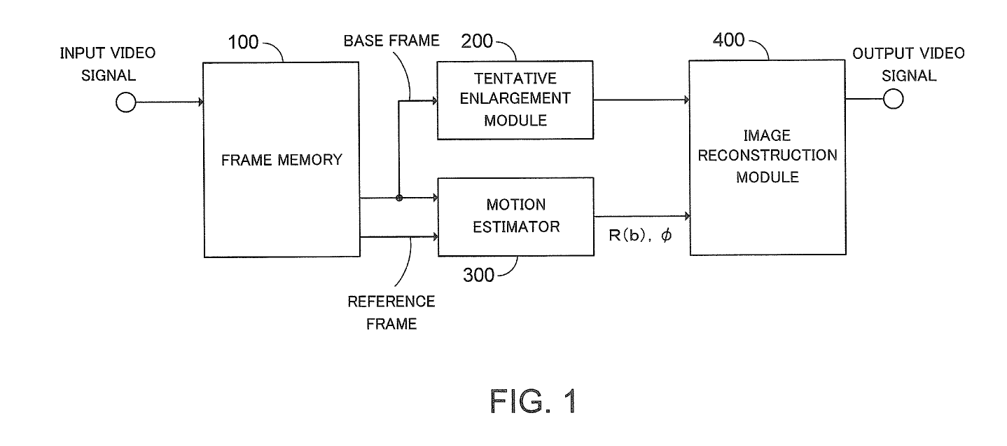

FIG. 1 is a block diagram showing a schematic configuration of a resolution converter according to a first embodiment. The resolution converter enlarges the resolution of an input video signal to generate an output video signal. The resolution converter includes a frame memory 100, a temporary enlargement module 200, a motion estimator 300, and an image reconstruction module 400.

The frame memory 100 temporarily stores a plurality of frames of the input video signal.

One of a plurality of frames is input into the temporary enlargement module 200 as the base frame. The temporary enlargement module 200 generates a temporarily enlarged frame by enlarging the base frame and outputs the temporarily enlarged frame to the image reconstruction module 400. The enlargement manner is not limited. For example, a cubic convolution manner can be applied.

The base frame and the reference frame are input into the motion estimator 300. The reference frame is the previous frame or the following frame of the base frame. The motion estimator 300 performs the motion estimation from the base frame to the reference frame. Then, the motion estimator 300 outputs a value R(b) of a pixel in the reference frame similar to each pixel in the base frame and a decimal position φ in the base frame corresponding to a position of the pixel in the reference frame to the image reconstruction module 400.

The image reconstruction module 400 updates a pixel value in the temporarily enlarged frame based on the value R(b) of the pixel in the reference frame and the decimal position φ to generate a super-resolution application frame for composing the output video signal. More specifically, the image reconstruction module 400 calculates a high resolution pixel value based on the pixel value in the reference frame, the pixel value in the temporarily enlarged frame, and the decimal position in the base frame. In this way, the super-resolution application frame where the sharpness is improved compared with the temporarily enlarged frame is generated.

Although a normal video signal represents an image in which pixels are two-dimensionally arranged, for simplicity of the description, a signal in which a plurality of pixels are one-dimensionally arranged will be described below. The pixel values located at a position “n” in the base frame and the reference frame are represented as P(n) and R(n), respectively. Also, the pixels located at a position “n” in the base frame and the reference frame are represented as a base pixel “n” and a reference pixel “n”, respectively.

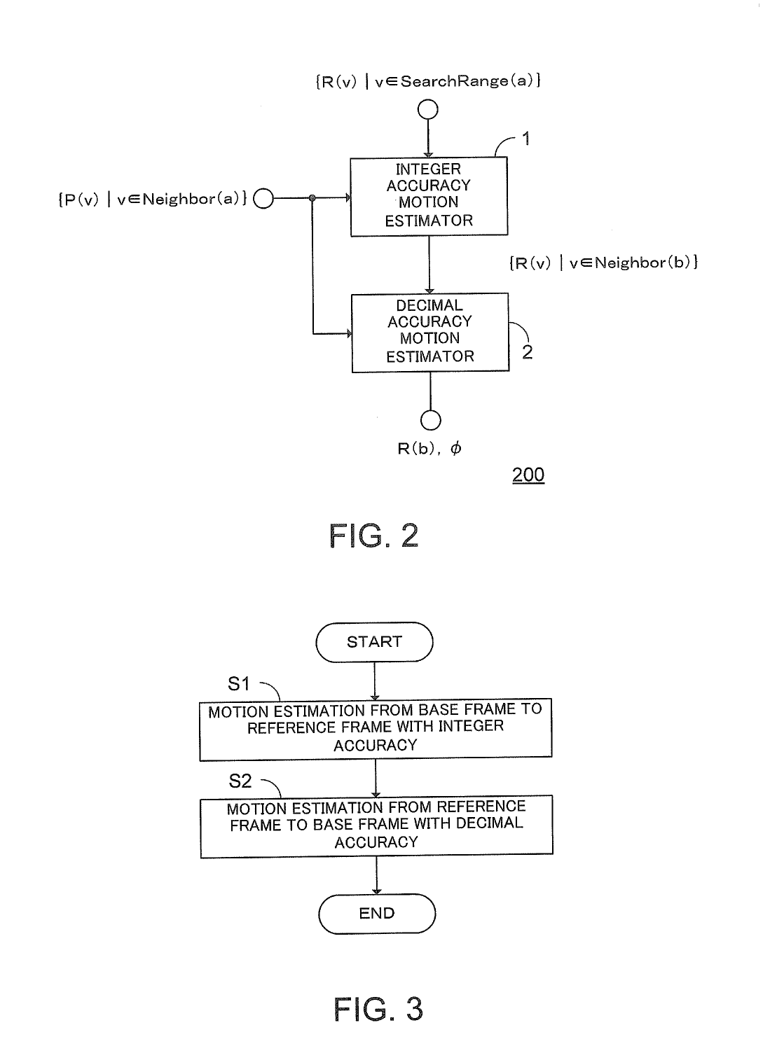

FIG. 2 is a block diagram of the motion estimator 300 according to the first embodiment. The motion estimator 300 includes an integer accuracy motion estimator 1 and a decimal accuracy motion estimator 2. The motion estimator 300 outputs a pixel value R(b) and a position “a+φ”, where the pixel value R(b) is a value of an integer position “b” in the reference frame corresponding to an arbitrary integer position “a” in the base frame and the position “a+φ” is a position in the base frame corresponding to the integer position “b” in the reference frame. Here, “φ” is a decimal whose absolute value is smaller than 1.

A pixel value {P(v)|vεNeighbor(a)} and a pixel value {R(v)|vεSearchRange(a)} are input into the integer accuracy motion estimator 1, where the pixel value {P(v)|vεNeighbor(a)} is located at a neighborhood Neighbor(a) of a base pixel “a” and the pixel value {R(v)|vεSearchRange(a)} is located in a predetermined search range SearchRange(a) around a reference pixel “a”. The integer accuracy motion estimator 1 performs the motion estimation by comparing both pixel values with an integer accuracy to search for a reference pixel “b” corresponding to the base pixel “a” in the search range SearchRange(a). Thereby, the reference pixel “b” corresponding to the base pixel “a” is obtained. A term “b−a” which represents a correspondence relationship between the base pixel “a” and the reference pixel “b” is referred to as a “motion vector MVbr from the base frame to the reference frame” or simply a “motion vector MVbr”.

The integer accuracy motion estimator 1 outputs a pixel value {(R(v)|vεNeighbor(b)} located at a neighborhood Neighbor(b) of the reference pixel “b” among the pixels in the search range SearchRange(a) to the decimal accuracy motion estimator 2. The above Neighbor(a) and Neighbor(b) are desired ranges for performing processes of the integer accuracy motion estimator 1 and the decimal accuracy motion estimator 2.

The pixel value {P(v)|vεNeighbor(a)} and the pixel value {R(v)|vεNeighbor(b)} are input into the decimal accuracy motion estimator 2. The decimal accuracy motion estimator 2 performs the motion estimation by comparing both pixel values with a decimal accuracy to detect a position “a+φ” in the base frame corresponding to the reference pixel “b”. The position “a+φ” includes an integer position “a” and a decimal position “φ”. A term “a+φ−b” which represents a correspondence relationship between the reference pixel “b” and the base pixel “a+φ” is referred to as a “motion vector MVrb from the reference frame to the base frame” or simply a “motion vector MVrb”.

Then, the decimal accuracy motion estimator 2 outputs, for the base pixel “a”, the corresponding pixel value R(b) of the reference pixel “b” and the decimal position “φ” in the base frame corresponding to the reference pixel “b” to the image reconstruction module 400 in FIG. 1.

The process described above is performed on each pixel in the base frame. As a result, the pixel value R(b) and the decimal position “φ” are output for each pixel in the base frame.

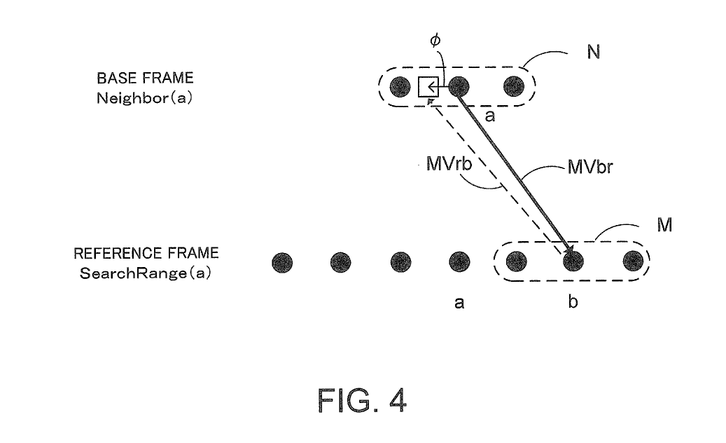

FIG. 3 is a flowchart showing an example of the process of the motion estimator 300. FIG. 4 is a diagram for explaining the process of the motion estimator 300. FIG. 4 schematically depicts three pixels located at the neighborhood Neighbor(a) of the base pixel “a” and seven pixels located in the search range SearchRange(a) around the reference pixel “a” as black circles. Hereinafter, the process of the motion estimator 300 will be described.

First, the integer accuracy motion estimator 1 performs the motion estimation from the base frame to the reference frame with the integer accuracy to detect the reference pixel “b” having a pixel pattern most similar to the pixel pattern of the base pixel “a” (step S1). Thereby, the motion vector MVbr from the base frame to the reference frame is obtained. This process is represented by the solid line arrow in FIG. 4.

To detect the reference pixel “b”, for example, the integer accuracy motion estimator 1 performs block matching to search for a pixel in the reference frame corresponding to the base pixel “a”. That is, the integer accuracy motion estimator 1 sets a plurality of pixels located around the base pixel “a” as a block N. The block N includes part or all of the pixels located at the neighborhood Neighbor(a) of the base pixel “a”, which are input to the integer accuracy motion estimator 1.

Also, the integer accuracy motion estimator 1 sets a plurality of pixels located around an integer position “x” of the search range in the reference frame (x is a variable and a certain position among the search range SearchRange(a)) as a block M. The block M includes a part of the pixels located in the search range SearchRange(a) around the integer position “a” in the reference frame, which are input to the integer accuracy motion estimator 1. It is preferable that the size of the block set in the base frame is the same as the size of the block set in the reference frame.

The integer accuracy motion estimator 1 calculates a sum of absolute difference (SAD) between each pixel value in the block N in the base frame and each pixel value in the block M in the reference frame. The integer accuracy motion estimator 1 calculates the sum of absolute difference SAD(x) while changing the integer position “x” in the SearchRange(a). Then, the integer accuracy motion estimator 1 determines the integer position x at which the sum of absolute difference SAD(x) is the minimum as the reference pixel “b” corresponding to the base pixel “a”.

The absolute difference of the sum of absolute difference may be weighted according to a distance from the integer position “a”. The sum of squared difference may be used instead of the sum of absolute difference. The same applies for the sum of absolute difference used in the description below.

Subsequently, the decimal accuracy motion estimator 2 performs the motion estimation from the reference frame to the base frame with the decimal accuracy and detects the position “a+φ” in the base frame which has a pixel pattern most similar to the pixel pattern at the reference pixel “b” (step S2). Thereby, the motion vector MVrb (dashed line arrow in FIG. 4) from the reference frame to the base frame, that is, the position “a+φ” corresponding to the integer position “b” in the reference frame, is obtained.

In this way, the pixel value R(b) of the reference pixel “b” corresponding to the base pixel “a” and the decimal position “φ” are generated.

Hereinafter, specific examples of the detection manner of the position “a+φ” by the decimal accuracy motion estimator 2 will be described.

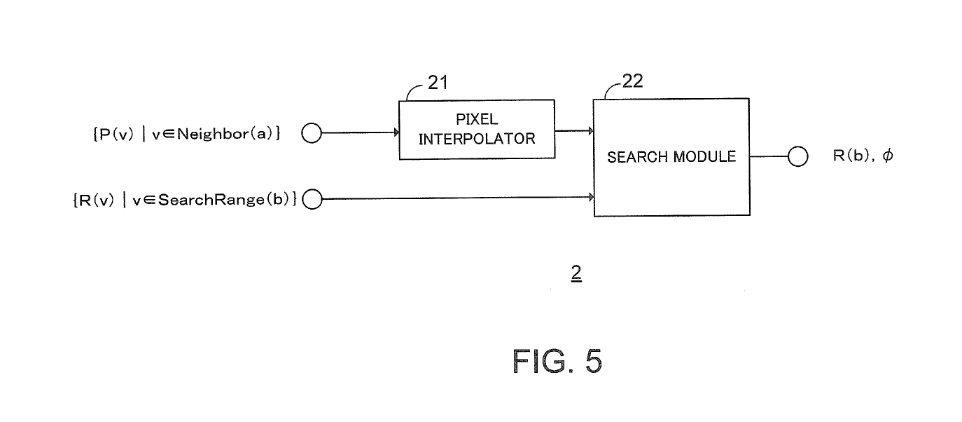

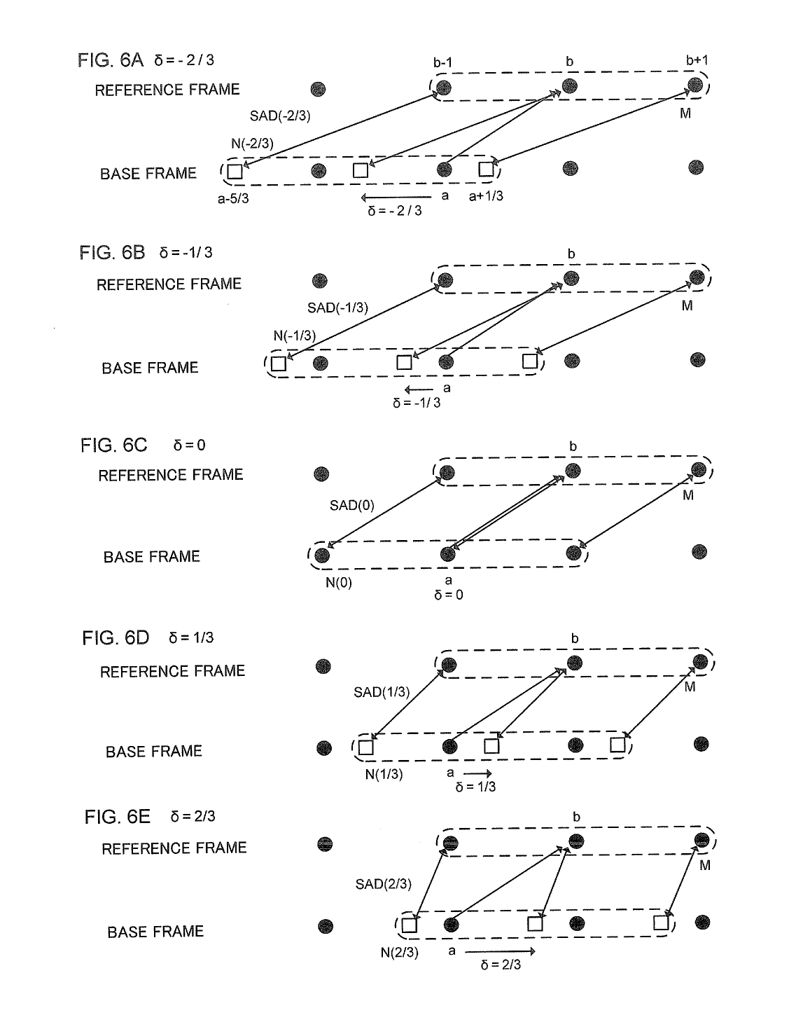

FIG. 5 is a block diagram showing an example of a configuration of the decimal accuracy motion estimator 2. FIG. 6 is a diagram for explaining the process of the decimal accuracy motion estimator 2 in FIG. 5. FIG. 6 shows an example in which the decimal position “φ” is one of ±⅔, ±⅓, and 0 and the block is formed by three pixels. However, this is only an example, and the decimal position “φ” may be searched in a wider range or the decimal position “φ” may be searched more finely. The decimal accuracy motion estimator 2 in FIG. 5 detects the decimal position “φ” by the block matching and includes a pixel interpolator 21 and a search module 22.

The pixel interpolator 21 generates interpolation pixels at decimal positions near the integer position “a” in the base frame. The type of the interpolation process is not limited. A linear interpolation manner, a cubic convolution manner, and the like may be used or the interpolation may be performed by using an interpolation filter according to a pixel pattern. In FIG. 6, each black circle represents a pixel at an integer position and each white square represents a pixel at a decimal position generated by the pixel interpolator 21.

The search module 22 searches for a position in the base frame which has a pixel pattern most similar to the pixel pattern at the reference pixel “b” by performing the block matching. More specifically, the sum of absolute difference SAD(δ) between each pixel of the block M around the reference pixel “b” and each pixel of the block N(δ) around a pixel located at the integer position “a”+decimal position “δ” (“δ” is a variable and, for example, one of ±⅔, ±⅓, and 0) in the base frame is calculated. The search module 22 calculates the sum of absolute difference SAD(δ) while changing the value of the decimal position “δ” and determines the decimal position “δ” at which the sum of absolute difference SAD(δ) is the minimum as the decimal position “φ”.

FIG. 6A shows the block N(−⅔) where δ is −⅔. The block N(−⅔) includes the pixel located at the positions “a−⅔”, “a−5/3” and “a+⅓” where the position “a−⅔” is at the center. These pixels in the base frame are generated by the pixel interpolator 21. Note that the block M is constant regardless of the value of “δ”.

The search module 22 calculates the sum of absolute difference SAD(−⅔) between pixels located at positions “b−1”, “b” and “b+1” in the reference frame and pixels located at positions “a− 5/3”, “a−⅔” and “a+⅓” in the base frame, respectively.

Thereafter, in the same manner, as shown in FIGS. 6B to 6E, the search module 22 calculates the sums of absolute difference SAD(−⅓), SAD(0), SAD(⅓), and SAD(⅔). Then, the search module 22 determines the decimal position “δ” at which the sum of absolute difference SAD is the minimum as the decimal position “φ” in the base frame.

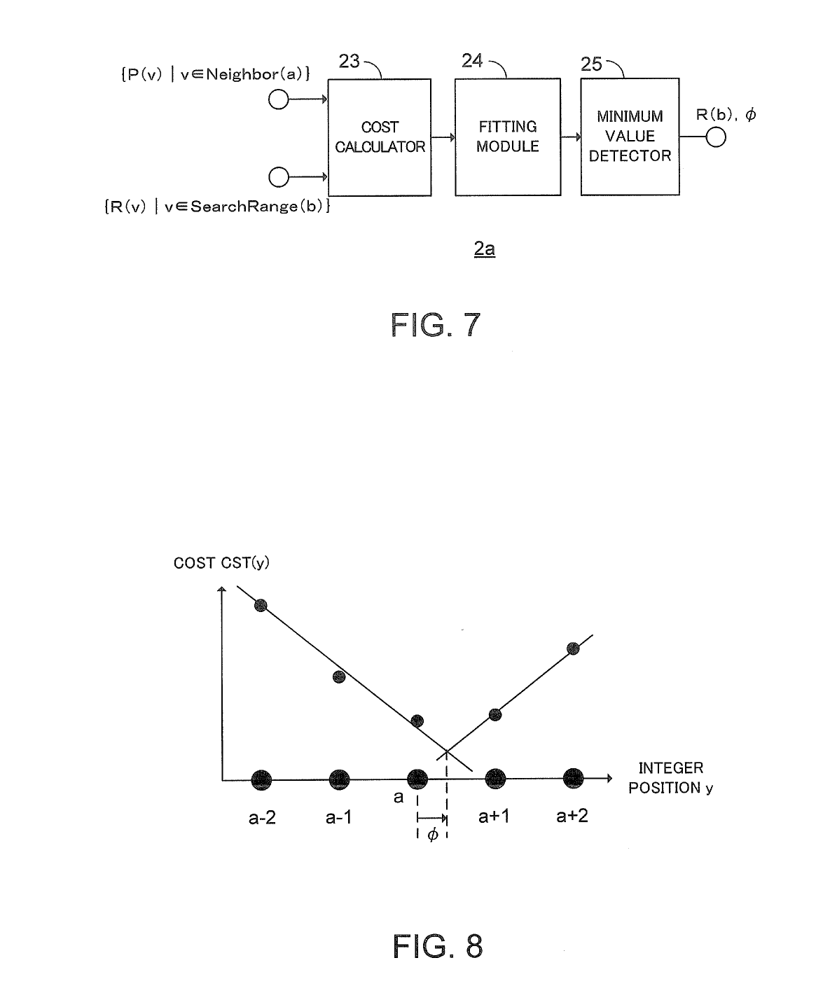

FIG. 7 is a block diagram showing another example of the decimal accuracy motion estimator 2. FIG. 8 is a diagram for explaining the process of the decimal accuracy motion estimator 2 in FIG. 7. The decimal accuracy motion estimator 2 in FIG. 7 detects the decimal position “φ” by function fitting and includes a cost calculator 23, a fitting module 24, and a minimum value detector 25.

The cost calculator 23 calculates a cost CST(y) representing a difference between the pixel pattern at the reference pixel “b” and a pixel pattern at each integer position “y” near the base pixel a (“y” is a variable and is an integer position at a neighborhood Neighbor(a) of the integer position “a”). The lower the cost is, the more similar both pixel patterns are. The cost C(y) is, for example, the sum of absolute difference between each pixel in a block formed by a plurality of pixels around the reference pixel “b” and each pixel in a block formed by a plurality of pixels around a pixel “y” in the base frame. FIG. 8 plots an example of a relationship between the integer position “y” and the cost CST (y) assuming that y=a, a±1, and a±2.

The fitting module 24 fits the relationship between the integer position “y” and the cost CST (y) by a predetermined function. The function that fits the relationship may be a quadratic function or may be two linear functions as shown in FIG. 8.

The minimum value detector 25 detects a position at which the fitted function is the minimum in a neighborhood of the integer position “a” in the base frame and determines the detected position as the decimal position “φ” in the base frame corresponding to the integer position “b” in the reference frame. In this case, the minimum value detector 25 can detect the decimal position “φ” at an arbitrary degree of accuracy. FIG. 8 shows an example where the intersection between two linear functions is determined to be the minimum position “φ”.

Further, various modified examples of the manner of detecting the decimal position “φ” can be considered. For example, the base frame and the reference frame are Fourier transformed and a phase-only correlation manner may be used in which the decimal position “φ” is detected based on a correlation between the phase characteristics of the base frame and the reference frame.

The processes of steps S1 and S2 in FIG. 3 described above are performed on all the integer positions in the base frame. The decimal position “φ” and the pixel value R(b) generated by the motion estimator 300 are used for a resolution enhancing process of the image reconstruction module 400 in FIG. 1.

As described above, in the first embodiment, first, the reference pixel “b” corresponding to the base pixel “a” is detected. Next, the decimal position “φ” in the base frame corresponding to the detected reference pixel “b” is detected. Therefore, the pixel value R(b) in the reference frame corresponding to the position “a+0” at a neighborhood with respect to one integer position “a”. Therefore, it is possible to prevent a corresponding point from being deviated in the base frame. Further, no interpolation is applied on the reference frame, thereby improving the accuracy of the matching. As a result, it is possible to perform the resolution conversion at a high quality.

### Second Embodiment

In the first embodiment, the motion estimation is performed for each pixel. On the other hand, in a second embodiment, the motion estimation is performed for each block including a plurality of pixels. In the description below, pixels located at a block position “N” in the base frame and the reference frame are represented as a base block “N” and a reference block “N”, respectively.

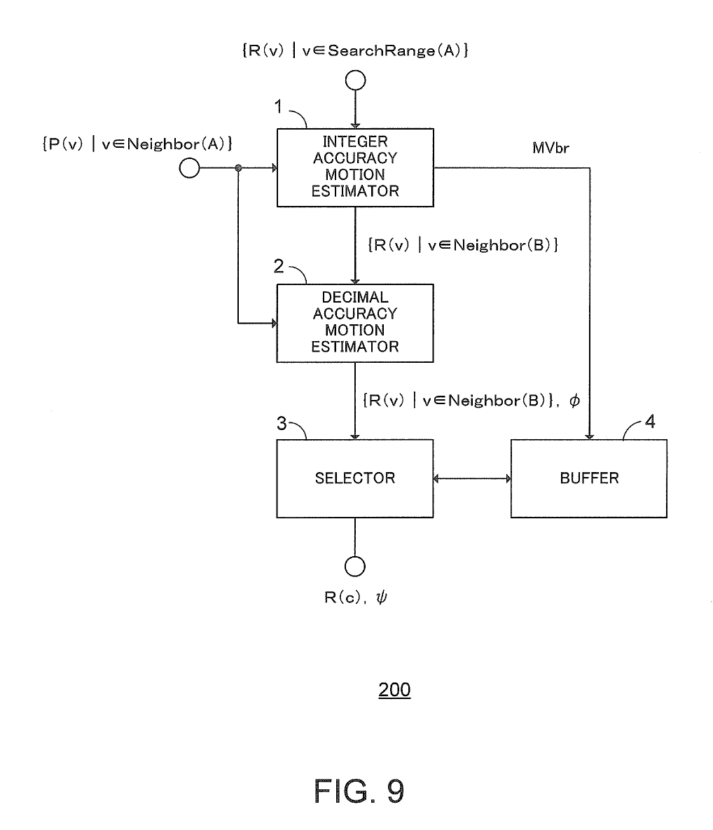

FIG. 9 is a block diagram showing a schematic configuration of a motion estimator 300 according to the second embodiment. The motion estimator 300 includes an integer accuracy motion estimator 1, a decimal accuracy motion estimator 2, a selector 3, and a buffer 4.

A pixel value {P(v)|vεNeighbor(A)} and a pixel value {R(v)|vεSearchRange(A)} are input into the integer accuracy motion estimator 1, where the pixel value {P(v)|vεNeighbor(A)} is located at a neighborhood Neighbor(A) of a base block “A” and the pixel value {(R(v)|vεSearchRange(A)} is located in a predetermined search range SearchRange(A) around a reference block “A”. The integer accuracy motion estimator 1 performs the motion estimation by comparing both blocks with integer accuracy to search for a reference block corresponding to a block located in the base block “A” in the search range SearchRange(A).

Thereby, a reference block B corresponding to the base block “A” is obtained. A term “B−A” which represents a correspondence relationship between the base block “A” and the reference block “B” is referred to as a “motion vector MVbr from the base frame to the reference frame” or simply a “motion vector MVbr”. The motion vector MVbr is stored in the buffer 4. The integer accuracy motion estimator 1 outputs a pixel value {R(v)|vεNeighbor(B)} located at a neighborhood of the reference block “B” among the pixels in the search range SearchRange(A) to the decimal accuracy motion estimator 2. The neighborhood Neighbor(A) and Neighbor(B) are desired ranges for performing processes of the integer accuracy motion estimator 1 and the decimal accuracy motion estimator 2.

The pixel value {P(v)|vεNeighbor(A)} and the pixel value {R(v)|vεNeighbor(B)} are input into the decimal accuracy motion estimator 2. The decimal accuracy motion estimator 2 performs the motion estimation by comparing both pixel values with a decimal accuracy to detect a position “A+φ” in the base frame corresponding to the reference block “B”. The position “A+φ” includes an integer block position “A” and a decimal position “φ”. A term “A+φ−B” which represents a correspondence relationship between the reference block “B” and the position “A+φ” is referred to as a “motion vector MVrb from the reference frame to the base frame” or simply a “motion vector MVrb”.

The decimal accuracy motion estimator 2 outputs a pixel value {R(v)|vεNeighbor(B)} located at a neighborhood Neighbor(B) of the reference block “B” corresponding to the base block “A” and the decimal position “φ” in the base frame corresponding to the reference block “B”. These values are stored in the buffer 4 through the selector 3.

Here, the reference block “B” corresponding to the block “A” is detected. However, this is only a correspondence between blocks. Therefore, each pixel in the block “A” may not correspond to each pixel in the block “B”.

Thus, the selector 3 further searches for a pixel in the reference frame corresponding to each pixel in the base frame. The selector 3 selects “j”, where the similarity between a pixel pattern at a position ai+φ(j) in the base frame and a pixel pattern at an integer position b(j)=ai+B(j)−A(j) in the reference frame is the highest, with respect to each pixel “ai” included in one block “A0” to be processed by using information stored in the buffer 4 after a certain delay, to determine ci=b(j) and ψi=φ(j). Finally, the selector 3 outputs a pixel value R(c) in the reference frame corresponding to each pixel in the base frame and a decimal position “ψ” in the base frame corresponding to the pixel.

When the video signal is one-dimensional, as the variable “j”, there are an integer block position “A0” (also represented as j=0, A(0)), the left of the integer block position “A0” (also represented as j=−1, A(−1)), and the right of the integer block position “A0” (also represented as j=1, A(1)).

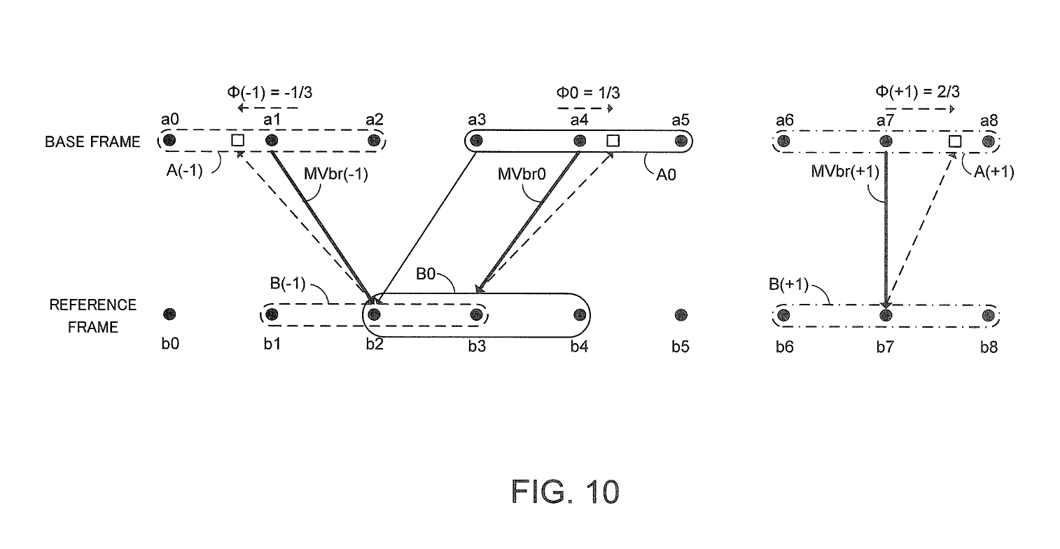

FIG. 10 is a diagram for explaining the process of the motion estimator 300 in FIG. 9. In FIG. 10, pixels located at each integer position in the base frame and the reference frame are represented by black circles. FIG. 10 shows an example in which a block includes three pixels.

In the example of FIG. 10, a base block “A0” (a block to be processed) including three pixels “a3” to “a5” corresponds to a reference block “B0” including three pixels “b2” to “b4”. The correspondence relationship between the block “A0” and the block “B0” is represented by a motion vector MVbr0 (=“B0−A0”). In the same manner, the base block A(−1) corresponds to the reference block B(−1), and the base block A(+1) corresponds to the reference block B(+1). Such correspondence relationships are determined by the integer accuracy motion estimator 1.

Further, in the example of FIG. 10, a decimal position “φ0” in the base frame corresponding to the reference block “B0” is “⅓”. Similarly, a decimal position φ(−1) in the base frame corresponding to the reference block B(−1) is “−⅓” and a decimal position φ(+1) in the base frame corresponding to the reference block B(+1) is “⅔”. Such decimal positions as described above are detected by the decimal accuracy motion estimator 2. Since the detection manner is substantially the same as that in the first embodiment, the description thereof is omitted.

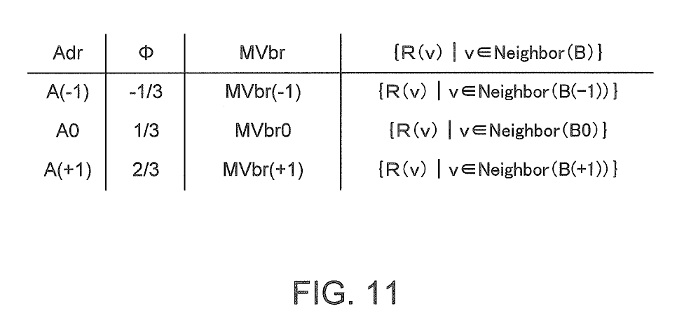

FIG. 11 is a diagram schematically showing information stored in the buffer 4. In order for the selector 3 to process each pixel “a3” to “a5” in the base block “A0”, the buffer 4 temporarily stores at least information as shown in FIG. 11. Specifically, the buffer 4 stores, for the block “A0”, the blocks A(−1) and A(+1) around the block “A0”, a corresponding decimal position “φ”, a motion vector MVbr, and a pixel value {R(v)|vεNeighbor(B)} located at a neighborhood of the reference block “B”.

Based on the information shown FIG. 11, the selector 3 selects the motion vectors MVbr and MVrb with regard to one of the blocks A(j) for each pixel in the block “A0”. Then, the selector 3 outputs the decimal position “φ” determined according to the motion vector MVrb and the pixel value R(c) in the reference frame determined according to the position of each pixel and the motion vector MVbr. Hereinafter, a specific selection manner will be described.

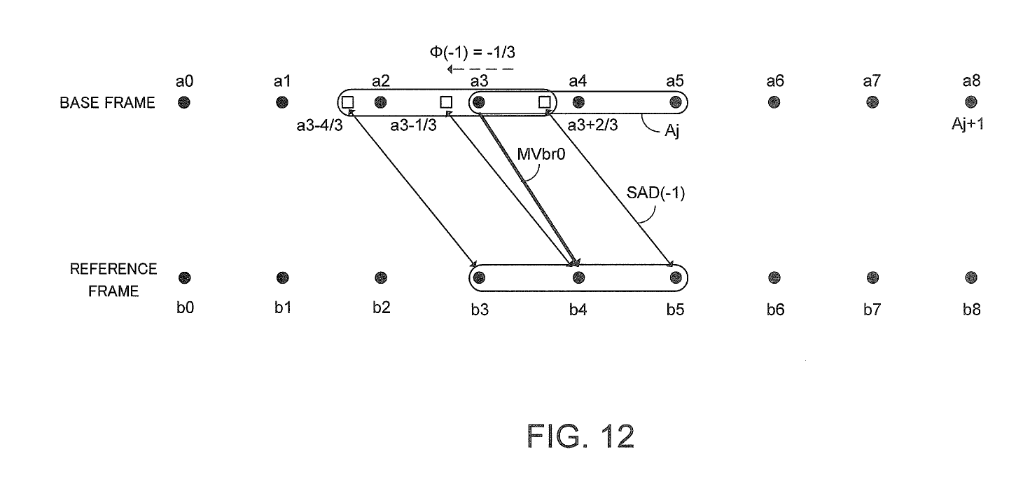

FIGS. 12 to 14 are diagrams for explaining the process of the selector 3 and show a situation in which the selector 3 searches for a pixel in the reference frame corresponding to the pixel “a3”. FIGS. 12, 13, and 14 correspond to j=−1, 0, and +1, respectively.

The selector 3 calculates the similarity between a pixel pattern at a position ai+φ(j) in the base frame and a pixel pattern at an integer position b(j)=ai+B(j)−A(j) in the reference frame with respect to each pixel “ai” (in the present example, i=3 to 5) included in the block “A0” to be processed. As an example, the sum of absolute difference SAD may be used for the similarity.

First, FIG. 12 in which j=−1 will be described. The selector 3 calculates the similarity SAD(−1) between a pixel pattern at a position a3+φ(−1) in the base frame and a pixel pattern at an integer position b(−1)=a3+B(−1)−A(−1) in the reference frame with respect to the pixel “a3” included in the block “A0” to be processed.

Specifically, the selector 3 generates a pixel at a position of a3+φ(−1)=(a3−⅓) in the base frame by the interpolation process. Further, the selector 3 generates pixels at positions (a3−4/3) and (a3+⅔) around the position (a3−⅓) by the interpolation process in order to perform block matching. Then, the generated three pixels are set as a decimal accuracy block.

On the other hand, when the pixel “a3” is a starting point, the integer position b(−1) in the reference frame is the integer position “b4” indicated by the motion vector MVbr(−1) stored in the buffer 4. Therefore, the three pixels located at the integer positions “b3” to “b5” are set as the reference block.

Then, the selector 3 calculates the sum of absolute difference SAD(−1) between each pixel in the decimal accuracy block and each pixel in the reference block.

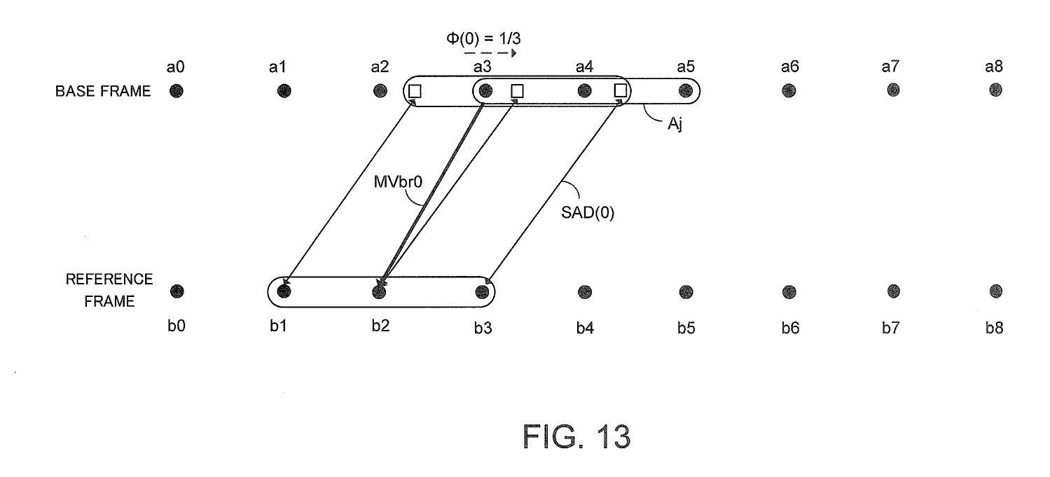

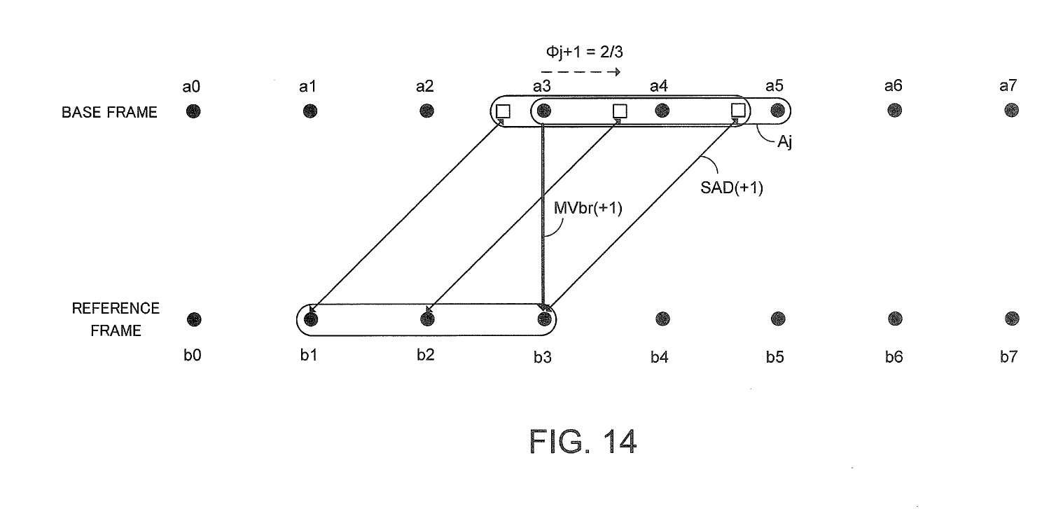

Thereafter, in the same manner, as shown in FIGS. 13 and 14, the selector 3 calculates the sums of absolute difference SAD(0) and SAD(+1). Then, the selector 3 determines “j” which makes the SAD(j) (j=−1 to 1) the minimum. If the SAD(−1) is the minimum, the selector 3 outputs the value R(b4) of the pixel “b4” and the corresponding decimal position φ(−1)=−⅓.

In this way, in the second embodiment, first, a corresponding block is detected for block unit. Therefore, it is possible to reduce the processing load of the motion estimator 300. Subsequently, a corresponding pixel is detected for pixel unit. Therefore, it is possible to prevent the detection accuracy from degrading.

### Third Embodiment

In the second embodiment, the integer accuracy motion accuracy and the decimal accuracy motion estimation are performed for block unit, and thereafter, the process is performed for pixel unit. On the other hand, in a third embodiment, the integer accuracy motion estimation is performed for block unit, and thereafter, the process is performed for each pixel unit.

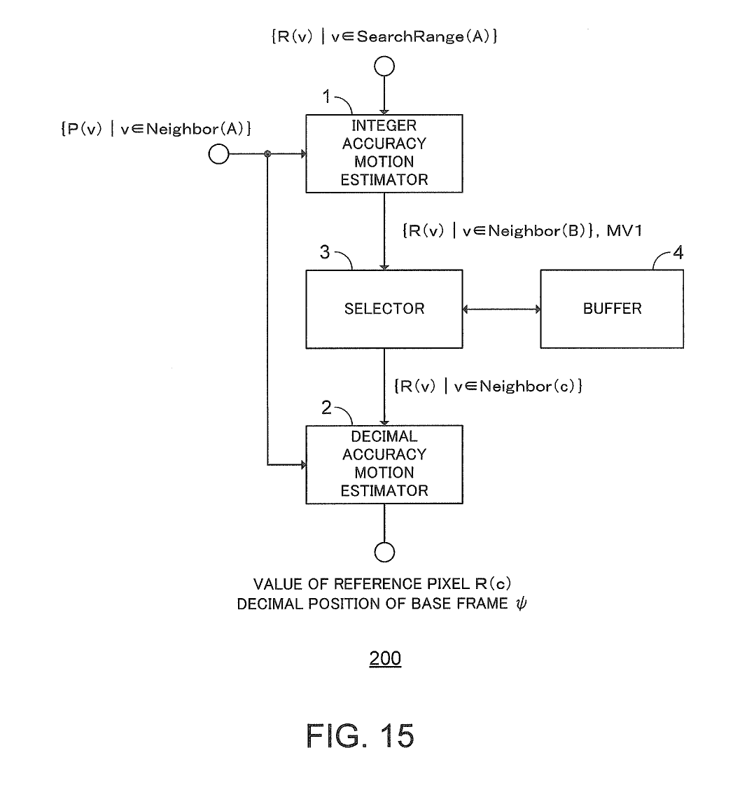

FIG. 15 is a block diagram showing a schematic configuration of a motion estimator 300 according to the third embodiment. Hereinafter, a difference from the second embodiment will be mainly described. In the motion estimator 300, a processing result of the integer accuracy motion estimator 1 is stored in the buffer 4 through the selector 3. After a certain delay, the selector outputs a pixel value {R(v)|vεNeighbor(c)} located at a neighborhood Neighbor(c) of a pixel position “c” in the reference frame corresponding to each integer block position in the base frame to the decimal accuracy motion estimator 2.

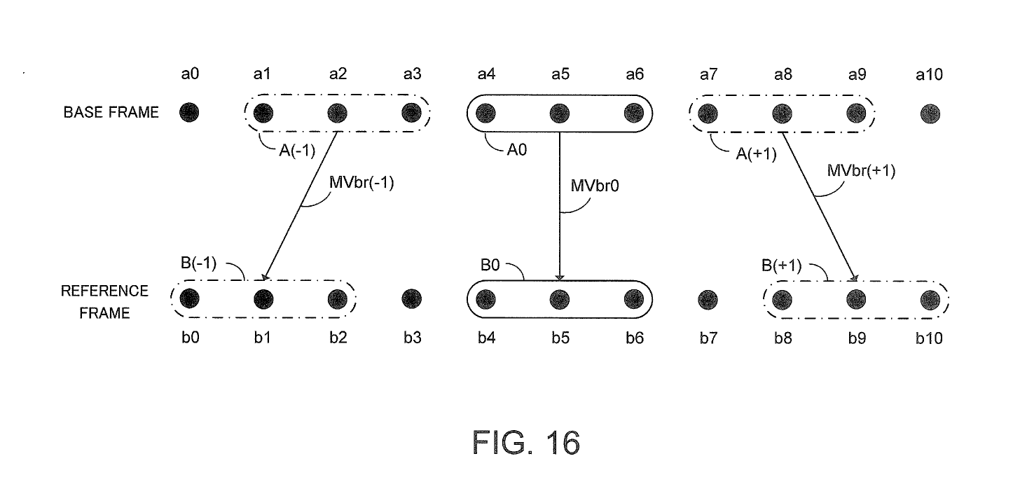

FIG. 16 is a diagram for explaining the process of the integer accuracy motion estimator 1. In the same manner as in the second embodiment, the integer accuracy motion estimator 1 searches for the reference block B corresponding to the base block A. Then, a pixel value {R(v)|vεNeighbor(B)} located at a neighborhood of the reference block B among the pixels in the search range SearchRange(A) and the motion vector MVbr are temporarily into the buffer 4 through the selector 3.

For example, the integer accuracy motion estimator 1 searches for the reference block “B0” corresponding to the base block “A0” by performing the block matching. The motion vector MVbr0 indicating a relationship between both blocks and a pixel value {R(v)|vεNeighbor(B0)} located at a neighborhood of the block “B0” are stored in the buffer 4. The integer accuracy motion estimator 1 performs the same process on the blocks A(−1) and A(+1) around the block “A0”.

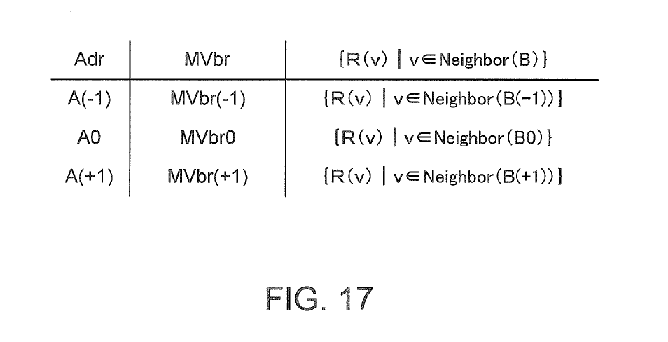

FIG. 17 is a diagram schematically showing information stored in the buffer 4. In order for the selector 3 to process each pixel in the block “A0”, the buffer 4 temporarily stores at least information as shown in FIG. 17. Specifically, the buffer 4 stores the motion vector MVbr and the pixel value {(R(v)|vεNeighbor(B)} located at a neighborhood of the reference block “B” for the block “A0” and the blocks A(−1) and A(+1) around the block “A0”.

As shown in FIG. 16, the reference block “B” corresponding to the block “A” is detected by the integer accuracy motion estimator 1. However, this is only a process for each block unit. Therefore, for example, the pixel “a4” in the block “A” may not correspond to the pixel “b4” in the block “B”. Thus, the selector 3 further searches for a pixel in the reference frame corresponding to each pixel in the base frame.

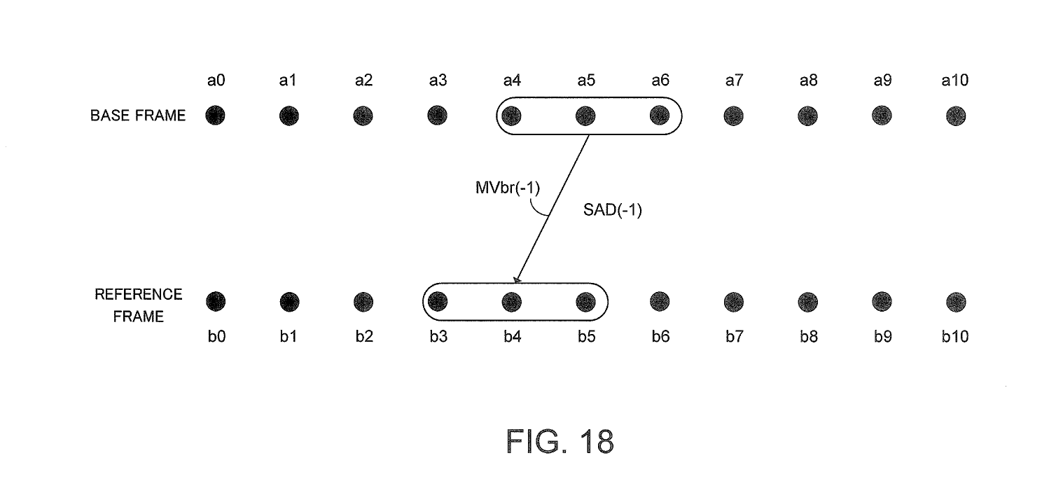

FIGS. 18 to 20 are diagrams for explaining the process of the selector 3. The selector 3 selects “j”, where the similarity between a pixel pattern at each integer position “ai” included in the base block “A0” and a pixel pattern at an integer position b(j)=ai+B(j)−A(j) in the reference frame is the highest and identifies a pixel in the reference frame corresponding to a pixel located at the integer position “ai” in the base frame.

First, FIG. 18 in which j=−1 will be described. FIG. 18 shows a situation in which the selector 3 searches for a pixel in the reference frame corresponding to the pixel a5 which is one of the pixels in the block A0. The selector 3 sets three pixels as the base block where the pixel “a5” is at the center When referring to the information stored in the buffer, b(−1)=b4. Therefore, the selector 3 sets three pixels as the reference block where the pixel b4 in the reference frame is at the center. Then, the selector 3 calculates the sum of absolute difference SAD(−1) between each pixel in the base block and each pixel in the reference block.

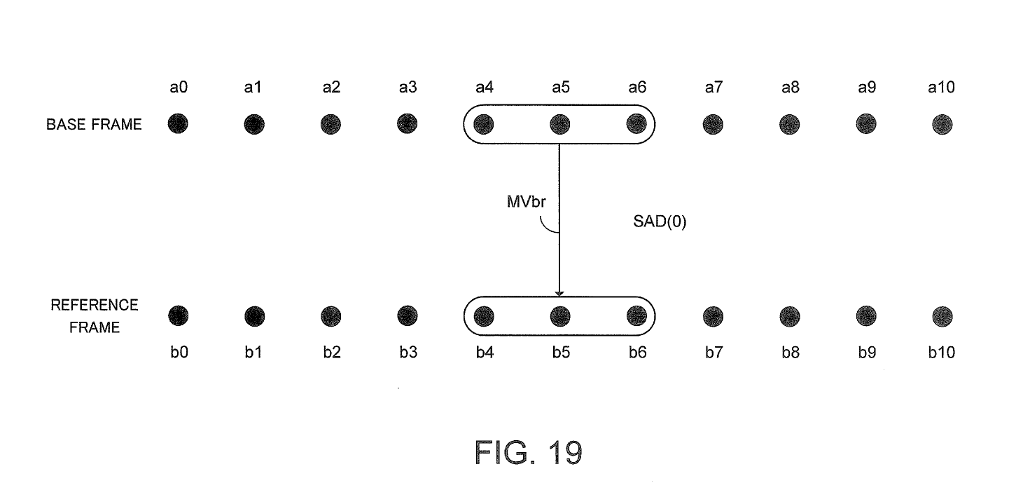

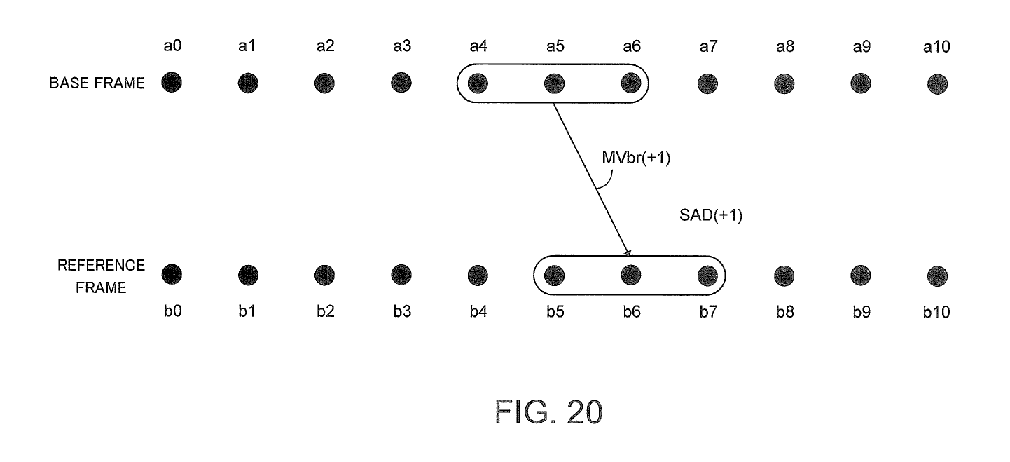

Thereafter, in the same manner, as shown in FIGS. 19 and 20, the selector 3 calculates the sums of absolute difference SAD(0) and SAD(+1). Then, the selector 3 determines “j” which makes the SAD(j) (j=−1 to 1) to be the minimum. If the SAD(−1) is the minimum, the selector 3 outputs a pixel value {R(v)|vεNeighbor(b4)} located at a neighborhood Neighbor(b4) of the pixel “b4” in the reference frame to the decimal accuracy motion estimator 2. The processing operation of the decimal accuracy motion estimator 2 is the same as that in the first embodiment.

In this way, in the third embodiment, the integer accuracy motion estimation is performed for block unit, so that it is possible to reduce the processing load of the motion estimator 300.

### Fourth Embodiment

A fourth embodiment relates to a resolution converter further including a competition determination module 500. In the description below, the “competition” means that a plurality of integer positions in the base frame correspond to one integer position in the reference frame as a result of the integer accuracy motion estimation.

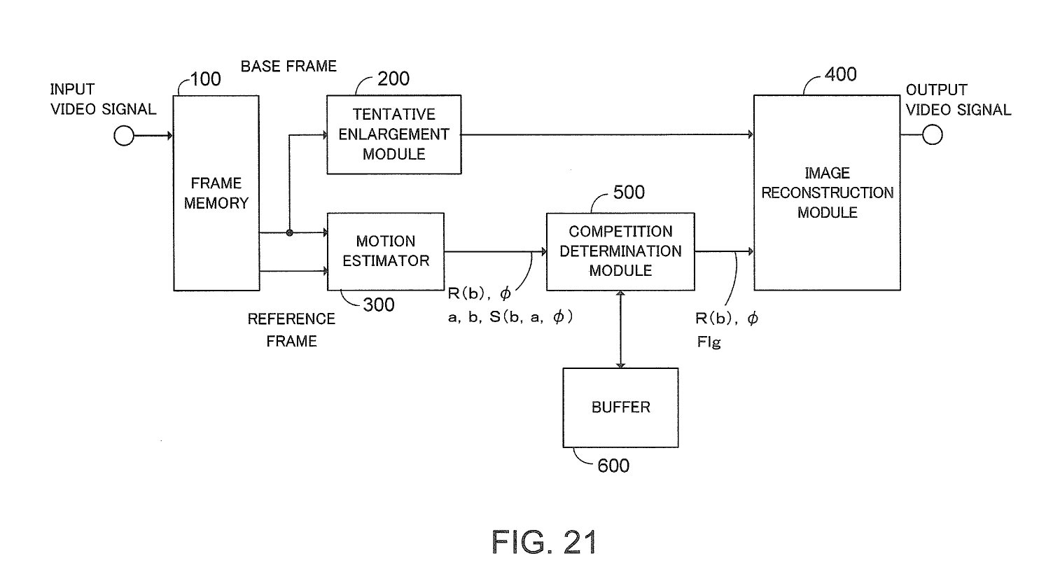

FIG. 21 is a block diagram showing a schematic configuration of the resolution converter according to the fourth embodiment. Hereinafter, differences from the embodiments described above will be mainly described. The resolution converter further includes a competition determination module 500 and a buffer 600.

As the motion estimator 300, the motion estimator in the first to the third embodiments can be applied. However, the motion estimator 300 in the fourth embodiment stores the integer position “b” in the reference frame corresponding to each pixel position “a” in the base frame and the similarity S(b, a, φ) between the pixel pattern at the position “a+φ” in the base frame and the pixel pattern at the integer position “b” in the reference frame, in addition to the pixel value R(b) and the decimal position “φ”, into the buffer 600 through the competition determination module 500. The similarity S(b, a, φ) may be decided based on, for example, the minimum value of the absolute difference SAD or the minimum value of the cost CST(y) described in the first embodiment. Here, it is assumed that the greater the value of the similarity S(b, a, φ), the greater the similarity.

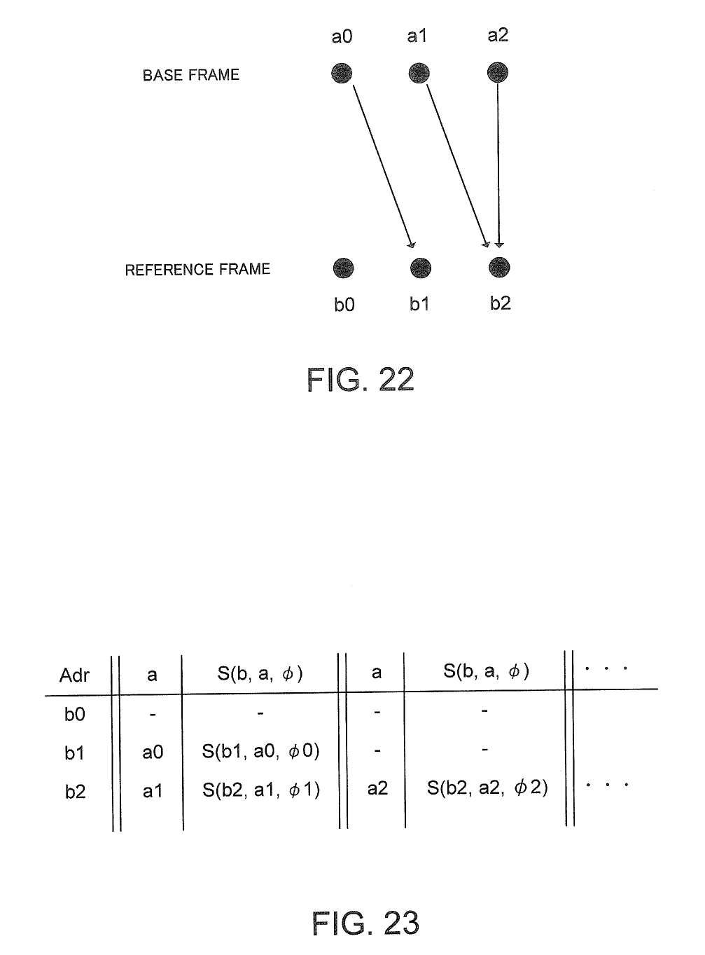

FIG. 22 is a diagram showing an example of the processing result of the integer accuracy motion estimator in the motion estimator 300. It is assumed that the integer positions a0, a1, and a2 in the base frame correspond to b1, b2, and b2 in the reference frame, respectively.

FIG. 23 is a diagram schematically showing information stored in the buffer 600. The buffer 600 uses the integer position “b” in the reference frame as an address to store the integer position “a” in the base frame determined to correspond to each integer position “b” in the reference frame and the similarity S(b, a, φ) thereof in association with each other. When a plurality of positions in the base frame correspond to one position in the reference frame, the buffer 600 stores all the positions in the base frame and the similarities S(b, a, φ) thereof. Although not shown in FIG. 23, the pixel value R(b) and the decimal position “φ” are also stored in the buffer.

For example, in FIG. 22, two integer positions “a1” and “a2” in the base frame correspond to the integer position “b2” in the reference frame. Therefore, as shown in FIG. 23, the integer position “a1” and the similarity S(b2, a2, φ2) thereof and the integer position “a2” and the similarity S(b2, a1, φ1) thereof are stored for the integer position “b2”.

When a plurality of integer positions in the base frame correspond to one integer position “b” in the reference frame, the competition determination module 500 determines that an integer position whose similarity is greatest is valid and that the other integer positions are invalid. Specifically, the competition determination module 500 adds a flag Flg that indicates whether the pixel value R(b) and the decimal position “φ” are valid or invalid to the pixel value R(b) and the decimal position “φ” and outputs them to the image reconstruction module 400.

In the example of FIG. 23, if the similarity S(b2, a1, φ1) is greater than the similarity S(b2, a2, φ2), regarding the integer position “a1”, the competition determination module 500 sets the flag Flg to a value indicating that the integer position “a1” is valid and outputs the pixel value R(b2) and “φ2”. On the other hand, regarding the integer position “a2”, the competition determination module 500 sets the flag Flg to a value indicating that the integer position “a2” is invalid and outputs the pixel value R(b2) and “φ1”.

Alternatively, when a plurality of integer positions “a” in the base frame correspond to one integer position in the reference frame, regarding all the integer position “a”, the competition determination module 500 may output a flag Flg set to a value indicating that the integer position “a” is invalid.

Note that, the competition determination module 500 performs the process of the competition determination when information is stored in the buffer after a certain delay. The certain delay may be, for example, a time until the integer accuracy motion estimation is completed for all the integer positions in the base frame, or a time until the integer accuracy motion estimation is completed for integer positions whose search ranges overlap each other.

In this way, in the fourth embodiment, the competition determination is performed, so that only one or less integer position in the base frame corresponds to one integer position in the reference frame. When the competition occurs, there is a possibility that artifacts occur in the output video signal after the super-resolution processing due to the wrong motion estimation. However, in the present embodiment, the competition determination is performed, thereby reducing such artifacts and improving image quality.

### Fifth Embodiment

In a fifth embodiment, the validity of the result of the integer accuracy motion estimation is evaluated by performing a reverse search.

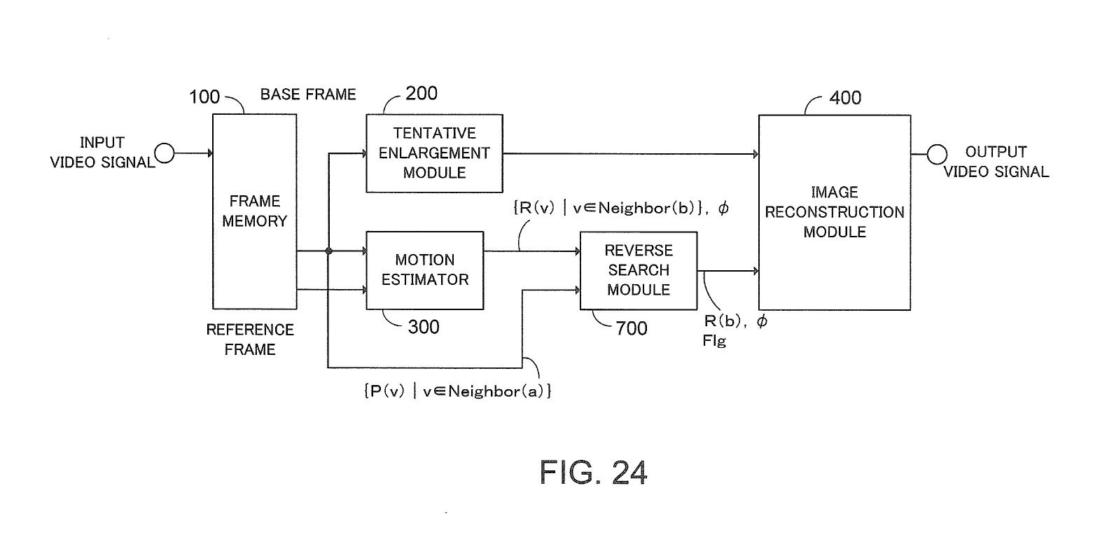

FIG. 24 is a block diagram showing an overview of the resolution converter according to the fifth embodiment. Hereinafter, differences from the embodiments described above will be mainly described. The resolution converter further includes a reverse search module 700.

As the motion estimator 300, the motion estimator in the first to the third embodiments can be applied. However, the motion estimator 300 outputs the pixel value {R(v)|vεNeighbor(b)} located in a neighborhood Neighbor(b) of the decimal position “φ” and the integer position “b” to the reverse search module 700. The reverse search module 700 retrieves the pixel value {P(v)|vεNeighbor(a)} from the frame memory 100.

For example, it is assumed that when the integer accuracy motion estimation is performed from the base frame to the reference frame, a result that the integer position “a0” in the base frame corresponds to the integer position “b0” in the reference frame is obtained. This result is not necessarily correct.

Therefore, the reverse search module 700 performs the integer accuracy motion estimation in the reverse direction from the reference frame to the base frame to determine whether or not the integer position “b0” in the reference frame corresponds to the integer position “a0” in the base frame. More specifically, the reverse search module 700 searches for a position “d” in the base frame which has a pixel pattern most similar to the pixel pattern at the integer position “b0” in the reference frame. When the position “d” corresponds to the integer position “a0”, the reverse search module 700 determines that the integer position “b0” in the reference frame corresponds to the integer position “a0” in the base frame.

When it is determined that the integer position b0 in the reference frame corresponds to the integer position a0 in the base frame, the reverse search module 700 adds a flag Flg to the pixel value R(b) and the decimal position “φ” corresponding to the pixel “a0” in the base frame, the flag Flg being set to a value indicating that the pixel value R(b) and the decimal position “φ” are valid and outputs them to the image reconstruction module 400.

On the other hand, when it is determined that the integer position b0 in the reference frame does not correspond to the integer position a0 in the base frame, the integer accuracy motion search may be wrong. Therefore, the reverse search module 700 adds a flag Flg to the pixel value R(b) and the decimal position “φ” corresponding to the pixel “a0” in the base frame, the flag Flg being set to a value indicating that the pixel value R(b) and the decimal position φ are invalid and outputs them to the image reconstruction module 400.

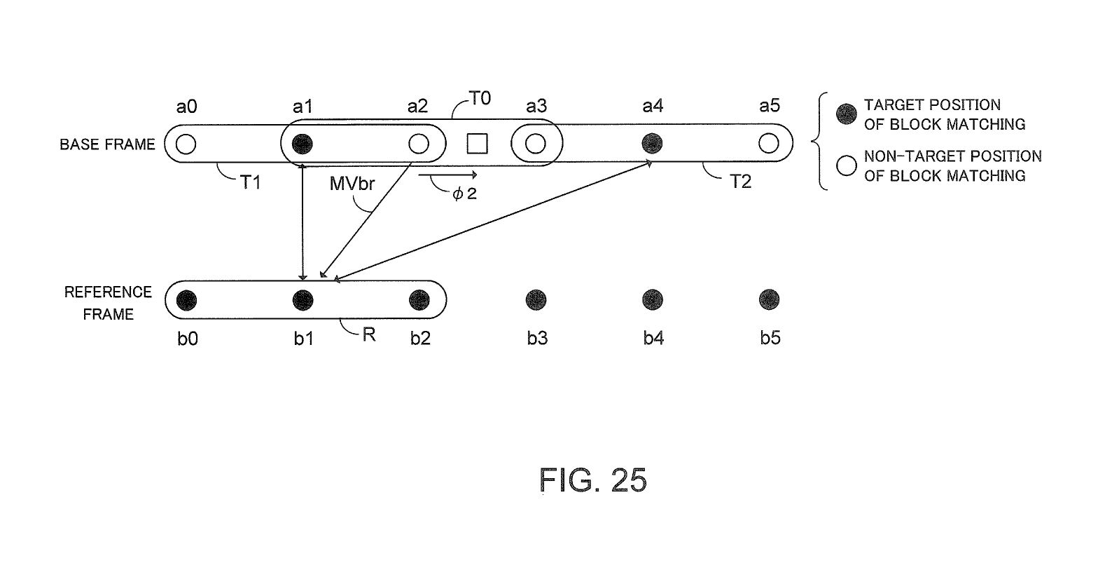

FIG. 25 is a diagram for explaining the process of the reverse search module 700. In FIG. 25, the integer position “a2” in the base frame is determined to correspond to the integer position “b1” in the reference frame by the integer accuracy motion estimation. Further, the integer position “b1” in the reference frame is determined to correspond to the position “a2+φ2” in the base frame by the decimal accuracy motion estimation.

At this time, the reverse search module 700 performs a reverse search for searching for an integer position in the base frame corresponding to the integer position “b1” in the reference frame. As a manner for the reverse search, for example, it is possible to use the block matching in the same manner as the process of the integer accuracy motion estimator 1 in the first embodiment.

Here, all the integer positions in the base frame may be processed by the block matching. However, it is preferable that the integer positions in the base frame which are to be processed by the block matching are near the position “a2+φ2”, for example, the distance from the position “a2+φ2” is “1” or more and smaller than “2”. In the example of FIG. 25, the integer positions “a1” and “a4” are processed. The reason why distant (distance is “2” or more) integer positions “a0”, “a5”, and the like are not processed is that it is considered that, in many cases, the farther away from the position “a2+φ2”, the larger the difference from the pixel pattern at the integer position “b1” in the reference frame. The reason why too close (distance is smaller than “1”) integer position “a3” is not processed is that even if the pixel pattern at the integer position “b1” in the reference frame is most similar to the pixel pattern at the integer position “a3” in the base frame, the position “a2+φ2” is located between the integer positions “a2” and “a3”, and thus, it cannot be said that the integer accuracy motion search is wrong.

Specifically, the reverse search is processed as described below. First, the reverse search module 700 calculates the sum of absolute difference SAD0 between each pixel in a block “R” around the integer position “b1” in the reference frame and each pixel in a block “T0” around the integer position “a2” in the base frame. Next, the reverse search module 700 calculates the sum of absolute difference SAD1 between each pixel in the block “R” and each pixel in a block “T1” around the integer position “a1” in the base frame. In the same manner, the reverse search module 700 calculates the sum of absolute difference SAD2 between each pixel in the block “R” and each pixel in a block “T2” around the integer position “a4” in the base frame.

When the sum of absolute difference SAD0 is the smallest, the reverse search module 700 determines that the integer accuracy motion search is correct. In this case, the reverse search module 700 sets the flag Flg to a value indicating that the output pixel value R(b) and “φ” are valid. On the other hand, when the sum of absolute difference SAD0 is not the smallest, the reverse search module 700 determines that the integer accuracy motion search is not correct. In this case, the reverse search module 700 sets the flag Flg to a value indicating that the output pixel value R(b) and “φ” are invalid.

In this way, in the fifth embodiment, whether the integer accuracy motion estimation is correct or not is checked by performing the reverse search. Thus, it is possible to reduce artifacts generated in the output video signal after the super-resolution processing, so that the image quality can be improved.

At least a part of the image processing device explained in the above embodiments can be formed of hardware or software. When the image processing device is partially formed of the software, it is possible to store a program implementing at least a partial function of the image processing device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the image processing device can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An image processing device comprising:
a first motion estimator configured to detect a second pixel of a second integer position in a reference frame, the second pixel corresponding to a first pixel of a first integer position in a base frame; and
a second motion estimator configured to detect a decimal position from the first integer position in the base frame, the decimal position corresponding to the second pixel, and to output the decimal position and a value of the second pixel.

2. The device of claim 1, wherein the first motion estimator detects the second integer position comprising a pixel pattern most similar to a pixel pattern at the first integer position.

3. The device of claim 1, wherein the second motion estimator detects the decimal position comprising a pixel pattern most similar to a pixel pattern at the second integer position.

4. The device of claim 3, wherein the second motion estimator detects the decimal position by block matching, function fitting, or a phase-only correlation manner.

5. The device of claim 4, wherein the second motion estimator comprises:
a pixel interpolator configured to generate interpolation pixels; and
a search module configured to determine the decimal position among the interpolation pixels, the decimal position comprising a pixel pattern most similar to the pixel pattern at the second integer position.

6. The device of claim 1, wherein the second motion estimator comprises:
a cost calculator configured to calculate a cost indicative of a difference between a first pixel pattern at each of the first integer position and integer positions around the first integer position and a second pixel pattern at the second integer position;
a fitting module configured to fit a relationship between an integer position in the base frame and the cost by a first function; and
a minimum value detector configured to detect the decimal position at which the function becomes minimum.

7. The device of claim 1 further comprising a competition determination module configured to, when a plurality of pixels of the first integer positions correspond to the second pixel, determine whether decimal positions each of which corresponds to each of the first integer positions and a value of the second pixel are valid or invalid, and output information indicating a determination result.

8. The device of claim 7, wherein the competition determination module determines that:
outputs from the second motion estimator are invalid for all of the plurality of first integer positions; or
output from the second motion estimator is valid for one of the plurality of first integer positions and output therefrom is invalid for the other of first integer positions.

9. The device of claim 7, wherein the competition determination module determines that one of the plurality of first integer positions comprising a pixel pattern most similar to a pixel pattern at the second integer position is valid.

10. The device of claim 9 further comprising a buffer configured to store:
the second integer position;
the first integer position corresponding to the second integer position; and
a similarity between a pixel pattern at the second integer position and a pixel pattern at the first integer position.

11. The device of claim 1 further comprising a reverse search module configured to output information indicative of whether the decimal position and a value of the second pixel are valid based on whether the second integer position corresponds to the first integer position.

12. The device of claim 11, wherein the reverse search module determines that the second integer position corresponds to the first integer position when a first similarity is higher than a second similarity,
the first similarity being a similarity between a pixel pattern at the second integer position and a pixel pattern at the first integer position, and
the second similarity being a similarity between the pixel pattern at the second integer position and a pixel pattern at a third integer position in the base frame, the third integer position being different from the first integer position.

13. The device of claim 12, wherein the third integer position is a position whose distance from the decimal position is “1” or more and smaller than “2”.

14. The device of claim 1 further comprising:
a temporary enlargement module configured to generate a temporarily enlarged frame by enlarging the base frame; and
an image reconstruction module configured to generate a super-resolution application frame comprising a resolution higher than a resolution of the base frame by using
a value of the first pixel,
the decimal position,
a value of the second pixel, and
a pixel value of the temporarily enlarged frame.

15. An image processing device comprising:
a first motion estimator configured to generate a first motion vector indicative of a positional relationship between a first integer position of a block in the base frame and a second integer position of a block in the reference frame, the second integer position corresponding to the first integer position, for each integer position of a plurality of blocks in the base frame;
a second motion estimator configured to generate a second motion vector indicative of a positional relationship between the second integer position and a decimal position of a block in the base frame, the decimal position corresponding to the second integer position; and
a selector configured to output
a value of a pixel of the second integer position, each of the block being based on the first motion vector for an integer position of a first block in the base frame or being based on a second block located around the first block, the first block comprising large a similarity, and
a decimal position corresponding to the second motion vector.

16. The device of claim 15, wherein the selector
calculates a similarity between a pixel pattern at the second integer position and a pixel pattern at the decimal position, and
outputs a value of a pixel located at the second integer position at which the similarity becomes greatest and the decimal position.

17. The device of claim 15 further comprising a buffer configured to store the first motion vector and the second motion vector.

18. An image processing device comprising:
a first motion estimator configured to generate a first motion vector indicating a positional relationship between integer positions of each block in the base frame and an integer position of a block in the reference frame corresponding to the integer positions of each block in the base frame;
a selector configured to select the first motion vector for a first block in the base frame or the first motion vector for a second block located around the first block; and
a second motion estimator configured to detect a decimal position in the base frame, the decimal position corresponding to a first integer position in the first block and a second integer position in the reference frame according to the selected first motion vector, and to output the decimal position and a value of a pixel of the second integer position.

19. The device of claim 18, wherein the selector
calculates a similarity between a pixel pattern at the first integer position and a pixel pattern at a position in the reference frame according to the first integer position and the first motion vector for the first block,
calculates a similarity between the pixel pattern at the first integer position and a pixel pattern at a position in the reference frame according to the first integer position and the first motion vector for the second block, and
selects the first motion vector for the first block or the second block where the similarity becomes greatest.

20. The device of claim 18 further comprising a buffer configured to store the first motion vector.
